(19) United States
(12) Patent Application Publication
(10) Pub. No.: US 2008/0303842 A1
(43) Pub. Date: Dec. 11, 2008

(54) DISPLAY SYSTEM AND IMAGE PROCESSING APPARATUS

(76) Inventors: Yuji OKAMOTO, Kyoto (JP); Naofumi Ueda, Kyoto (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/132,020

(22) Filed: Jun. 3, 2008

(30) Foreign Application Priority Data
Jun. 7, 2007 (JP) 2007-151130

(51) Int. Cl. G09G 5/00

(52) U.S. Cl. 345/629; 345/4

(57) ABSTRACT

In a display apparatus capable of multiple-view display, a restriction is imposed on an image to be displayed depending on the viewing area set with reference to a screen, thereby enhancing security and preventing leakage of confidential information. When an image processing apparatus outputs an image to the display apparatus, the image processing apparatus confirms the display conditions for a specified viewing area. After confirmation, the image processing apparatus reads an image of a document according to the display conditions. The image to be outputted is restricted and differs from the original image. The image processing apparatus transmits the restricted image to the display apparatus. The display apparatus displays the restricted image, which is different from the original image, to the specified viewing area. The display apparatus displays the original image to the other viewing areas.

### BACKGROUND OF THE INVENTION

1. Field of the Invention

The present invention relates to a display system in which a multiple-view display apparatus displays an image outputted from an image processing apparatus.

2. Description of the Related Art

A display system has an image processing apparatus, such as a composite machine, and a display apparatus that are connected to each other via a network, and images outputted from the image processing apparatus are displayed on the display apparatus. The image processing apparatus reads images of documents with a scanner or receives images from a personal computer and stores the images as files. The image processing apparatus can output the input image to the outside via the network. As described in Japanese Patent Laid-Open No. 2007-97052, when the image processing apparatus outputs a read image to the display apparatus, the display apparatus can display the inputted image in real time.

As described in Japanese Patent Laid-Open No. 2005-284592, there is a display apparatus capable of multiple-view display that simultaneously displays an image that can only be seen from a viewing area and an image that can only be seen from another viewing area. Such a display apparatus shows different images to users depending on the direction in which the users see the display apparatus.

### SUMMARY OF THE INVENTION

When a display apparatus capable of multiple-view display is installed in a room in which there are visitors or outsiders, such as a meeting room, the third parties including the visitors or outsiders are typically gathered to a predetermined viewing area to see the image on the display. However, the image can contain confidential information. If the third parties see such an image, there is a possibility that the confidential information leaks out.

That is, to prevent leakage of the confidential information, a restriction has to be imposed on the image depending on the direction in which the users see the image. Thus, in view of such circumstances, an object of the present invention is to provide a display system that is enhanced in security and can prevent leakage of confidential information.

According to the present invention, there is provided a display system in which a display apparatus that simultaneously displays a plurality of images in such a manner that different images can be seen from different viewing areas set with reference to a screen and an image processing apparatus for processing images are connected to each other by a network, the display apparatus displays an image outputted from the image processing apparatus, the image processing apparatus imposes a restriction on an output image according to the viewing area, and the display apparatus displays a plurality of images including the restricted image.

A display apparatus capable of multiple-view display displays a plurality of images to different viewing areas. To a specific viewing area, the original image is not displayed, but a restricted image is displayed. Thus, when an image containing confidential information is displayed, the confidential information can be obscured so that the users in the viewing area cannot see the confidential information. To the other viewing areas, the image displayed is not restricted, so that the users in the viewing areas can see the original image containing the confidential information.

To impose a restriction on the image, a security level is set for each viewing area, and a display condition is determined according to the security level of the viewing area. The image processing apparatus imposes a restriction on the output image according to the display condition.

The display condition is determined in such a manner that the lower the security level of the viewing area, the stricter the restriction on the output image becomes, and the higher the security level of the viewing area, the looser the restriction imposed on the output image becomes.

In the viewing areas, there are an unspecified number of users who see the image on the display apparatus. Therefore, the security levels of the viewing areas are determined taking into account the users in the respective viewing areas. If there is an outside user, such as a visitor, in a viewing area, the security level of the viewing area is set lower. If there are only inside users in a viewing area, the security level of the viewing area is set higher.

The image processing apparatus outputs an image processed to be different from the original image according to the display condition, and the display apparatus displays the modified image. The modified image is inferior in image quality or the like to the original image and therefore is different from the original image. Therefore, the image containing the confidential image becomes obscure, and the confidential information is prevented from being recognized.

The image processing apparatus determines whether output of the image is permitted or not according to the display condition and inhibits output of the image if output of the image is not permitted. The inhibition of output of the image is also a restriction imposed on the output image. If output of the image is permitted, the image processed can be output.

Display conditions include whether enlargement of the image is permitted or not. The display apparatus displays an enlarged image when an image permitted to be enlarged is inputted thereto. Even a fine image can be seen if the image is enlarged when displayed. Therefore, if enlargement of the image is not permitted, the image displayed is restricted.

The image processing apparatus described above has a control section that imposes a restriction on the output image according to a display condition determined for each viewing area, and the control section outputs the restricted image to the display apparatus.

The control section modifies the image into an image different from the original image according to the display condition. Furthermore, the control section determines whether output of the image is permitted or not according to the display condition and inhibits output of the image if output of the image is not permitted.

According to the present invention, since a restriction is imposed on the output image depending on the viewing area set with reference to the screen, an image containing confidential information can be displayed as an image different from the original image. Therefore, among users seeing the same display apparatus, the image containing confidential information can be made obscure to a specific user. Therefore, in a display apparatus capable of multiple-view display, leakage of confidential information can be prevented, and a highly secure display system can be provided.

### BRIEF DESCRIPTION OF THE DRAWINGS

FIG. 1 is a diagram showing an entire configuration of a display system according to the present invention;

FIG. 2 is a block diagram showing internal configurations of an image processing apparatus and an information processing apparatus;

FIG. 3 is a block diagram showing an internal configuration of a display apparatus;

FIG. 4 is a diagram for illustrating multiple-view display;

FIG. 5 shows a display apparatus information table;

FIG. 6 is a flowchart for illustrating a process of outputting a restricted image;

FIG. 7 shows an operation panel;

FIG. 8 shows a transmission destination setting screen; and

FIG. 9 shows a confirmation screen for confirming display conditions.

### DETAILED DESCRIPTION OF THE PREFERRED EMBODIMENTS

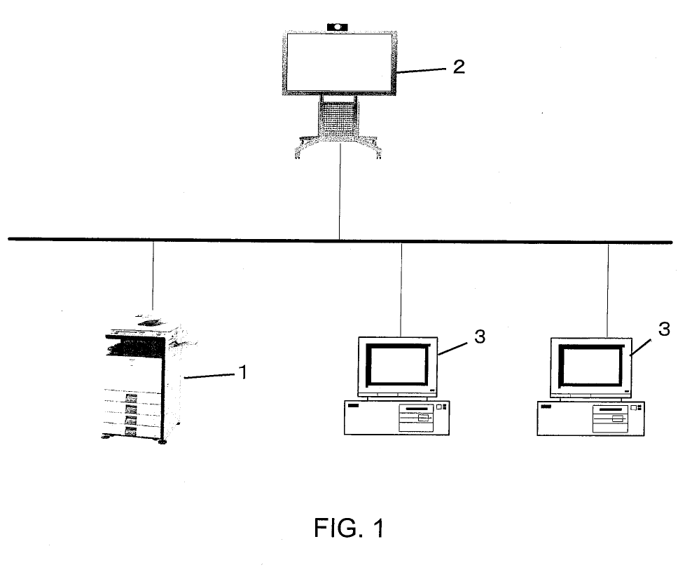

FIG. 1 is a diagram showing a display system according to an embodiment of the present invention. The display system is composed of one or more image processing apparatus 1, a display apparatus 2 and an information processing apparatus 3 that are connected to each other via a network so that they can communicate with each other. The image processing apparatus 1 is a multifunctional peripheral capable of copying, printing, scanning, facsimile communication and document filing. The information processing apparatus 3 is a personal computer or a server that creates an image, stores an image or otherwise processes an image. In other words, the information processing apparatus 3 is also one of the image processing apparatus 1. The display apparatus 2 is a display capable of dual-view display, and a so-called information display is used as the display apparatus 2.

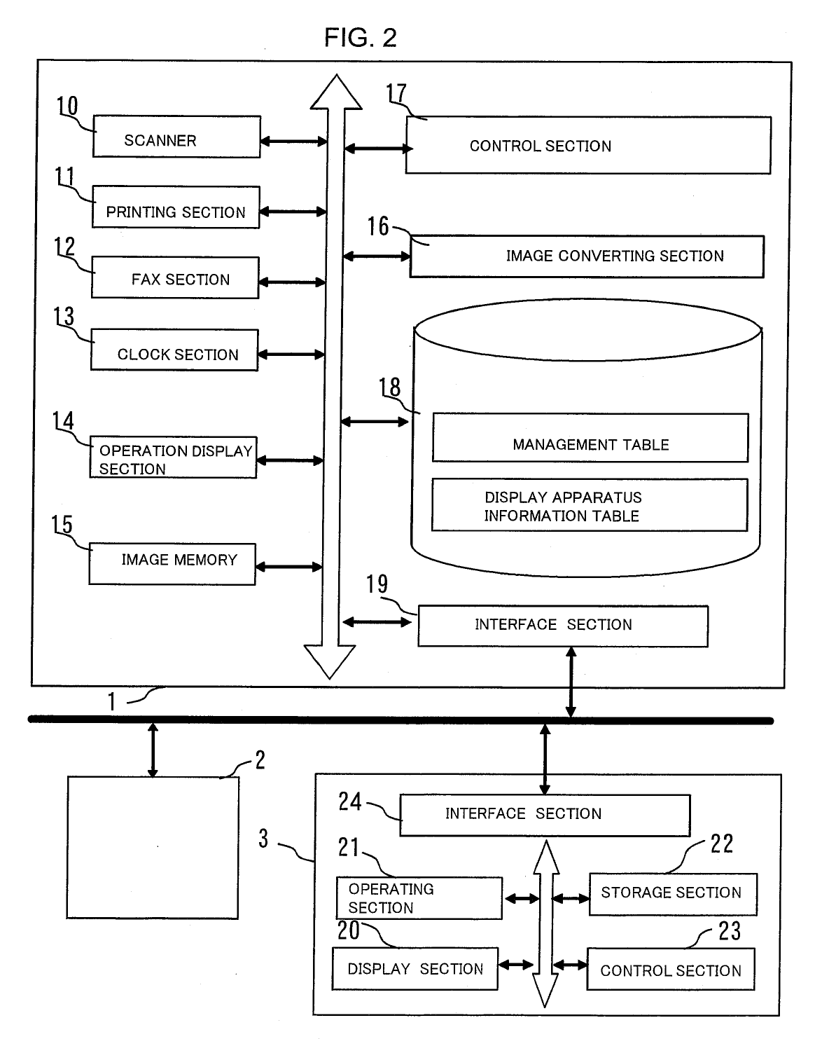

As shown in FIG. 2, the image processing apparatus 1 has a scanner 10 that reads an image of a document, a printing section 11 that prints an inputted image, a FAX section 12 that transmits an inputted image to a specified transmission destination, a clock section 13 that provides date and time information, an operation display section 14 that has a touch-panel display used by a user for input operation, an image memory 15 that temporarily stores an image, such as RAM, an image converting section 16 that converts an image for transmission thereof, a control section 17 that controls the operation of the whole of the apparatus, a storage section 18 that stores an image and various kinds of setting information, and an interface section 19 that allows communication with an external apparatus, such as the information processing apparatus 3 and the display apparatus 2, via the network.

The information processing apparatus 3 has a display section 20 that displays an image, an operating section 21 used by a user for input operation, a storage section 22 that stores an image, a control section 23 that carries out a processing of an image, and an interface section 24 that allows communication with an external apparatus, such as the image processing apparatus 1 and the display apparatus 2, via the network.

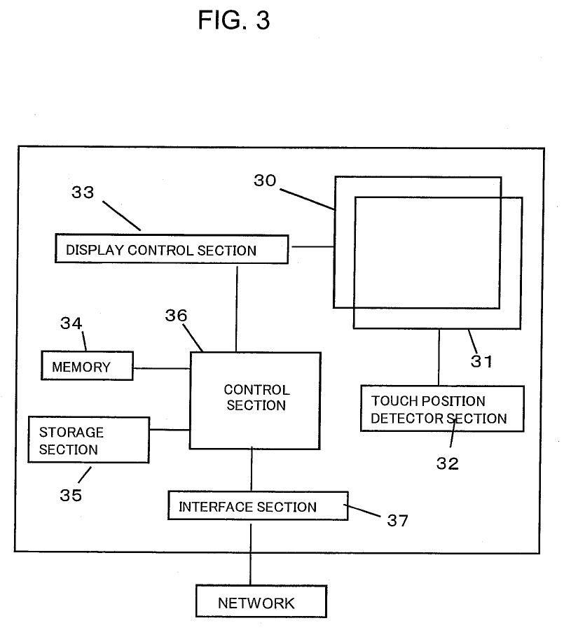

As shown in FIG. 3, the display apparatus 2 has a display panel 30, such as a liquid crystal display, a touch panel 31 provided on the front surface of the display panel 30, a touch position detector section 32 that detects the coordinates of a position on the touch panel 31, a display control section 33 that outputs a display timing signal to the display panel 30, a memory 34 constituted by a ROM, a nonvolatile memory or the like that stores information about an icon displayed on the display panel 30, a storage section 35 constituted by a hard disk drive, a nonvolatile memory or the like that stores an image, a control section 36 that controls display of an image, and an interface section 37 that allows communication with an external apparatus, such as the image processing apparatus 1 and the information processing apparatus 3, via the network. As can be seen from the above description, the display apparatus 2 has similar functions to the information processing apparatus 3.

The display panel 30 has a liquid crystal layer having an anisotropic permittivity between two substrates. The display panel 30 displays an image by adjusting the amount of light from a backlight that passes through the substrates according to the intensity of the electrical field applied to the liquid crystal layer.

A parallax barrier (an optical system separating element) is overlaid on the entire front surface of the display panel 30. The parallax barrier is a plurality of transparent vertical slits spaced apart from each other by opaque regions.

The memory 34 stores a plurality of pieces of icon data. The icon data includes display information concerning the shape, the color and the display position of an icon, a character displayed in an icon or the like, and operation information that specifies the operation performed when an icon is selected via the touch panel 30.

The control section 36 combines an icon read from the memory 34 with an image input from an external apparatus, such as the image processing apparatus 1 and the information processing apparatus 3, and outputs the image combined with the icon to the display control section 33. The display control section 33 outputs the combined image to the display panel 30. At the same time, the display control section 33 outputs a control signal for controlling the display operation of the display panel 30. Specifically, the display control section 33 drives a gate driver and a source driver based on the image to be displayed. The gate driver applies an operating voltage for driving a plurality of pixels of the display panel 30. The source driver applies a write voltage for driving a plurality of pixels. Based on the control signal from the display control section 33, the pixels of the display panel 30 are driven, and the image is displayed on the display panel 30.

In dual-view display, different images are seen depending on whether the screen is viewed from a left-hand position or a right-hand position. The area in which the left-hand image can be seen is referred to as left-hand viewing area, and the area in which the right-hand image can be seen is referred to as right-hand viewing area. The right-hand image cannot be seen from the left-hand viewing area.

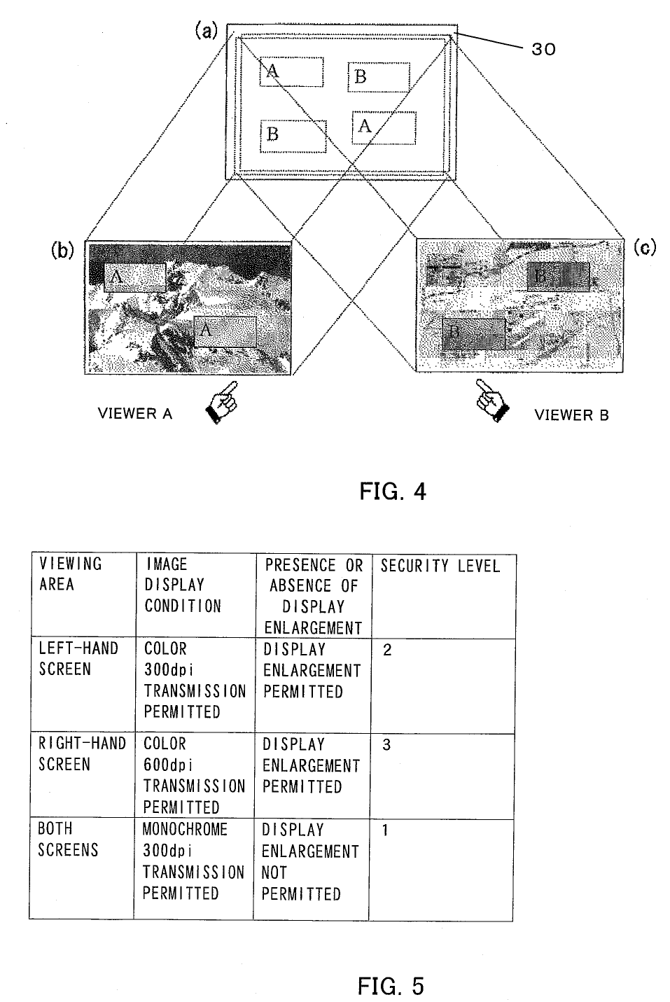

FIG. 4 shows a screen that provides dual-view display. A viewer A sees the screen from the left-hand viewing area. A viewer B sees the screen from the right-hand viewing area. As shown in FIG. 4(a), the display panel 30 displays one image. On the screen, icons A and B are displayed. FIG. 4(b) shows an image on the display panel 30 viewed from the viewing area in which there is the viewer A. The viewer A can see an image of a snow-covered mountain as an image for the left-hand viewing area and icons A disposed at an upper left position and a lower right position on the screen with respect to the center thereof as icons for the left-hand viewing area. FIG. 4(c) shows an image on the display panel 30 viewed from the viewing area in which there is the viewer B. The viewer B can see an image of a map as an image for the right-hand viewing area and icons B disposed at an upper right position and a lower left position on the screen with respect to the center thereof as icons for the right-hand viewing area. In this way, users in the left-hand viewing area and the right-hand viewing area see the different images on the same screen.

For dual-view display, the control section 36 temporarily saves the image for the left-hand viewing area and the image for the right-hand viewing area inputted thereto from the external apparatus in the storage section 35. The respective images are output from the same external apparatus or different external apparatus. The control section 36 superimposes the icons for the left-hand viewing area retrieved from the memory 34 on the image for the left-hand viewing area. Similarly, the control section 36 superimposes the icons for the right-hand viewing area on the image for the right-hand viewing area. Icon data stored in the memory 34 includes icon data for the left-hand viewing area and icon data for the right-hand viewing area. The control section 36 outputs the data thus created to the display control section 33.

The display control section 33 distributes the pixels between the image for the left-hand viewing area and the image for the right-hand viewing area inputted from the control section 36 in a proportion appropriate to the dual-view display and outputs the resulting single image to the display panel 30. At the same time, the display control section 33 outputs a control signal required to control the display operation of the display panel 30.

Adjacent pixels of the display panel 30 are driven by the display control section 33 to show different ones of the image for the viewer A and the image for the viewer B. Every other pixel of the display panel 30 is driven to show the image for the viewer A or the image for the viewer B. Alternatively, every plural pixels, such as every two or three pixels, can be driven to show the image for the viewer A or the image for the viewer B. The number of pixels that are integrally driven for each image depends on the width of the transparent slits of the parallax barrier. Thus, the light passing through the transparent slits of the parallax barrier can only be seen from a predetermined viewing area. The user in the left-hand viewing area can only see the image for the left-hand viewing area, and the user in the right-hand viewing area can only see the image for the right-hand viewing area.

The touch panel 31 is a panel of the capacitance coupling made of a transparent material that does not interfere with the display on the display panel 30. If a conductor, such as a finger, comes closer to a transparent electrode of the touch panel 31, a capacitance coupling occurs, and a current flows. The touch position detector section 32 detects the current, calculates the coordinates of the point to which the conductor comes closer, and transmits the detection signal to the control section 36. In this way, the control section 36 recognizes the information about the position at which the user touches the touch panel 31. Then, under the control of the control section 36, the display control section 33 performs the operation set for the selected icon. Alternatively, the touch panel 31 can also be of the electromagnetic induction type, the electric resistance type, the pressure sensitive type or the like.

For the display system, the display apparatus 2 is installed in a meeting room, a reception room, a business meeting room or the like. The image processing apparatus 1 and the information processing apparatus 3 are installed in the same place as the display apparatus 2 or a different place than the display apparatus 2. The image processing apparatus 1, the information processing apparatus 3 and the display apparatus 2 installed at the respective places are connected to each other via a network, such as LAN and WAN. Instead of the wired LAN using a LAN cable or a lighting circuit, the wireless LAN can also be used. The interface section of each apparatus communicates with external apparatus according to a predetermined communication protocol. The network is connected to the Internet through a router by a communication line, such as a telephone line and an optical fiber. In addition, the FAX section 12 of the image processing apparatus 1 has a modem, and the modem is connected to the telephone line. The FAX section 12 performs facsimile communication with a facsimile machine or another image processing apparatus 1 via the modem.

In the information processing apparatus 3, the control section 23 activates an application to store an image created based on the input operation by the user. Alternatively, an image acquired from the Internet is stored. Then, the control section 23 outputs the image to the image processing apparatus 1 or the display apparatus 2.

In the image processing apparatus 1, an image is inputted by the scanner 10 reading the image. Alternatively, the image processing apparatus 1 receives an image from the information processing apparatus 3. The control section 17 processes the inputted image according to the instruction from the user or the information processing apparatus 3. For example, in the case of a copy or print instruction, the printing section 11 is activated to print the image. In the case of a facsimile communication instruction, the FAX section 12 is activated to receive the image. In the case of a document filing instruction, the image is stored in the storage section 18, such as a hard disk drive.

The image processing apparatus 1 outputs the inputted image or stored image to the display apparatus 2. In this step, the image converting section 16 converts the image into a predetermined data format, such as JPEG. The converted image is outputted to the display apparatus 2. Similarly, the information processing apparatus 3 outputs the image to the display apparatus 2.

The display apparatus 2 displays the image received from the image processing apparatus 1 or the information processing apparatus 3 along with an icon. When the user performs an operation via the touch panel 31, a display control, such as a change, is performed on the image to be displayed, and the changed image is output to the image processing apparatus 1 or the information processing apparatus 3.

That is, when the user touches an icon, the control section 36 of the display apparatus 2 determines the relationship between the position information from the touch position detector section 32 and the display information about the icon. The control section 36 identifies the icon selected by the user and moves, changes, switches or otherwise processes the image based on the information about the operation set for the icon. The processed image is stored in the storage section 35. In addition, the control section 36 outputs the processed image to the image processing apparatus 1 or the information processing apparatus 3, as required. Therefore, the user can easily manipulate the displayed image. When the image is processed in each apparatus, and when the image is transmitted via the network, the image is handled as image data in a predetermined data format.

The display apparatus 2 displays different images to different viewing areas. Users in different viewing areas see different images. For example, suppose that, at a conference or meeting, users in one viewing area are outside users, such as visitors and outside attendees, and users in the other viewing area are inside users. In some cases, it is undesirable that the outside users see an image including confidential information.

Thus, the image processing apparatus 1 imposes a restriction on the output image depending on the viewing area. Specifically, the control section 17 of the image processing apparatus 1 imposes a restriction on the image displayed to the viewing area in which there are the outside users and outputs the restricted image. The display apparatus 2 displays the restricted image as the image for the one viewing area. The image for the other viewing area is displayed without being restricted.

The control section 17 of the image processing apparatus 1 imposes a restriction on the output image according to display conditions. The display conditions are determined according to the security levels of the viewing areas. The security levels of the viewing areas are previously set by an authorized user, such as an administrator.

Specifically, when the users in each viewing area are identified, a user, such as an administrator, sets the security level of each viewing area according to the users in the viewing area and determines the display conditions for the viewing area based on the security level thereof on the image processing apparatus 1 or the information processing apparatus 3.

For example, the security level is set higher for a viewing area in which there are only inside users and set lower for a viewing area in which there is an outside user, such as a visitor. The display conditions are determined in such a manner that the lower the security level, the more strict the restriction imposed on the output image becomes, and the higher the security level, the looser the restriction imposed on the output image becomes. The display conditions are determined by referring to the display capabilities of the display apparatus 2. The display conditions are determined in such a manner that the display capabilities of the display apparatus 2, such as the resolution, the screen size and the number of colors, are not exceeded. If the security level is at the maximum, the display conditions are the display capabilities of the display apparatus, and no restriction is imposed on the output image.

The display conditions and the security levels thus set are stored in the image processing apparatus 1 and the information processing apparatus 3. As shown in FIG. 5, a display apparatus information table for registration of display apparatus information including the viewing area, the display condition, the presence or absence of display enlargement, and the security level is created. The display apparatus information table is stored in the storage section 18 of the image processing apparatus 1 and the storage section 22 of the information processing apparatus 3. The image processing apparatus 1 and the information processing apparatus 3 have the same display apparatus information table. Each time the users seeing the display apparatus 2 change, the security levels of the viewing areas also change, and the display conditions also change accordingly. In response to such a change of the display apparatus information, the display apparatus information tables in the image processing apparatus 1 and the information processing apparatus 3 are updated.

The left-hand viewing area corresponds to the “left-hand screen” in FIG. 5, and the right-hand viewing area corresponds to the “right-hand screen” in FIG. 5. The “both screens” means a case where the same image is displayed to the left-hand viewing area and the right-hand viewing area. The “display enlargement” in the display apparatus information means a function of enlarging the image displayed. The display size or the zoom ratio can be specified, and the control section 36 of the display apparatus 2 enlarges the image to a specified size. The display conditions include the presence or absence of display enlargement. In the case of the absence of display enlargement, a restriction is imposed on the displayed image.

When the image processing apparatus 1 outputs an image to the display apparatus 2, the image processing apparatus 1 imposes a restriction on the image according to the determined display conditions. The display conditions are determined according to the security levels of the viewing areas based on the display capabilities of the display apparatus 2. The image processing apparatus 1 modifies the image according to the display conditions to make the image different from the original image. Then, the image converting section 16 converts the modified image into a data format suitable for transmission, and then, the control section 17 outputs the converted image.

The display conditions described above are set by a user, such as an administrator. Alternatively, the control section 17 of the image processing apparatus 1 or the control section 23 of the information processing apparatus 3 can automatically determine the display conditions according to the display capabilities of the display apparatus 2 when the security levels of the viewing areas are input.

Modifyings of the image include conversion of a color image into a monochrome image, decrease of the resolution, reduction of the image size and reduction of the image contrast. In addition, an image processing function of the image processing apparatus 1 or the information processing apparatus 3 can be used to convert a plurality of pages of images into one multiple-page image containing a plurality of pages of images or perform an image transformation, such as expansion, contraction, rotation and color reversal.

For display conditions, one or more processings are selected from among these processings. Then, according to the security level, the degree of the processings is determined. The image is processed in such a manner that the lower the security level, the higher the degree of modification from the original image becomes. For example, the resolution of the image is set at 150 dpi when the security level is low, and the resolution of the image is set at 600 dpi when the security level is high. The output image is restricted by such a processing.

Modifying of an image stored in the storage section 18 or an image inputted from the information processing apparatus 3 is conducted by the control section 17 according to the display conditions. An image inputted from the scanner 10 is an image that is read by the scanner 10 under the reading condition set by the control section 17 according to the display conditions. The image read by the scanner 10 is a modified image that is different from the original image. Alternatively, the scanner 10 can read the image under the ordinary conditions, and the control section 17 can process the read image under the display conditions. That is, the control section 17 imposes a restriction on the output image even when the image is inputted through the scanner 10. Depending on the display conditions, the read image is further modified by the control section 17.

The display conditions include whether the output of the image is permitted or not. If the output (transmission) of the image is permitted, the control section 17 permits the output of the image to the display apparatus 2. If the output (transmission) of the image is not permitted, the control section 17 inhibits the output of the image. Whether the output of the image is permitted or not also depends on the security level. In this way, the output of the image is restricted by inhibiting the output of the image.

The image processing apparatus 1 has a function of authenticating users. Authentication information about users, such as IDs and passwords, are registered and stored in a management table in the storage section 18. In the management table, the security level set for the inputted image is also stored.

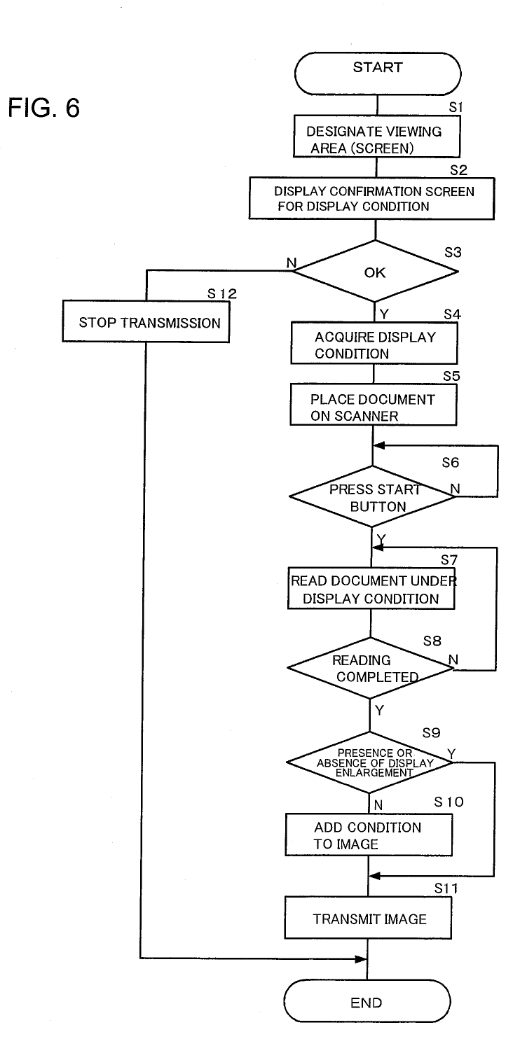

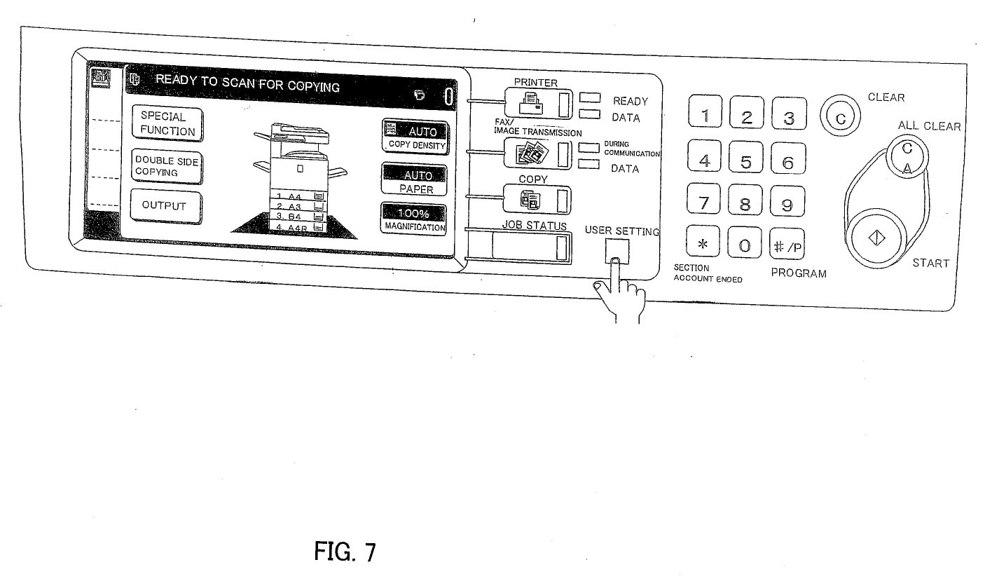

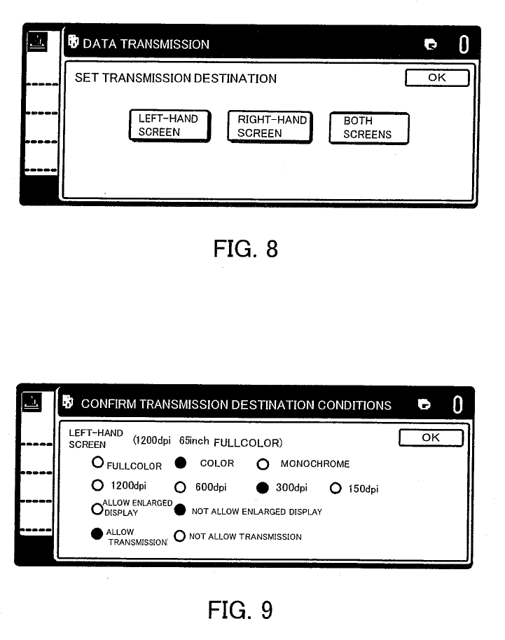

Now, a procedure of displaying an image on the display apparatus 2 will be described with reference to FIG. 6. First, a user designates a display apparatus 2 that displays an image. The user operates a user setting key on an operation panel of the image processing apparatus 1 shown in FIG. 7. Then, in the operation display section 14 on the operation panel, a transmission destination setting screen for designating a screen that displays the restricted image shown in FIG. 8 is displayed. In this example, the user designates the left-hand screen (S1). The control section 17 reads the display apparatus information about the designated screen (viewing area) from the display apparatus information table and displays a confirmation screen for confirming the display conditions on the operation display section 14 as shown in FIG. 9 (S2). On the screen of the operation display section 14, the designated screen and the display capabilities and the display conditions of the display apparatus 2 are displayed.

The user confirms the display conditions. If the user approves the display conditions, the user operates an OK button on the screen (S3). The control section 17 acquires the display conditions from the storage section 18 and temporarily stores the display conditions in the image memory 15 (S4). If the user does not approve the display conditions, the user operates a clear key on the operation panel to make the control section 17 stop the operation of transmission to the display apparatus 2 (S12).

If the transmission is permitted (OK), the user places a document on the scanner 10 (S5). When a start button is operated (S6), the scanner 10 starts operating and reads the image of the document (S7). The control section 17 instructs the scanner 10 to read the image based on the display conditions. The scanner 10 reads the image with the color mode, the reading resolution, the reading size and the reading scaling factor set according to the display conditions. The control section 17 stores the inputted read image in the image memory 15. The image is different from the original image.

When the reading of the image is completed (S8), the control section 17 checks the display conditions for the presence or absence of display enlargement (S9). In the case of the absence of display enlargement, the control section 17 adds information indicating that display enlargement is not permitted to the output image (S10). In the case of the presence of display enlargement, no information is added. Then, the control section 17 transmits the image processed and restricted to the display apparatus 2 (S11).

When the display apparatus 2 receives the image from the image processing apparatus 1, the control section 36 outputs the inputted image to the display control section 33 as the image for the left-hand viewing area. The display control section 33 drives the display panel 30 to display the image for the left-hand viewing area on the display panel 30. Alternatively, when the display apparatus 2 receives the image, the control section 36 instructs to display an indication of the reception of the image on the display panel 30. When the user near the display apparatus 2 operates the touch panel 31 to prompt to display, the control section 36 instructs to display the image. In the case of the presence of display enlargement, the control section 36 instructs to display an enlarged image.

In the case where the image for the right-hand viewing area is an image read by the scanner of the image processing apparatus 1, the image is output and displayed without being processed. In this case, the image for the left-hand viewing area and the image for the right-hand viewing area are the same. However, the image for the left-hand viewing area is an image to be restricted, and if the image contains confidential information, the image for the left-hand viewing area is displayed in such a manner that the confidential information is hidden from the user. On the other hand, the image for the right-hand viewing area is an image not to be restricted. The user can see the image containing confidential information without change.

The image for the right-hand viewing area can be an image outputted from another image processing apparatus 1 or the information processing apparatus 3. Furthermore, the source of the image can also be a reproducing apparatus that replays a recording medium, such as DVD, or a television set. In this case, the image for the left-hand viewing area and the image for the right-hand viewing area differ. The image for the right-hand viewing area is an image that is not restricted. Alternatively, the image for the right-hand viewing are can be a restricted image. In that case, an image restricted according to the display conditions for the right-hand viewing area is outputted, and the restricted image is displayed.

The restricted image differs from the original image. If the security level of the viewing area is low, the degree of modification of the displayed image is high, the image quality is reduced, and therefore a detailed image is not displayed. As a result, even if the image contains confidential information, the user in the viewing area of the low security level cannot clearly recognize the confidential information. Therefore, leakage of the confidential information can be prevented. However, the user at the installation place can acquire a minimum set of information from the displayed image.

In the display system described above, the image processing apparatus 1 and the information processing apparatus 3 have the display apparatus information including the display conditions and manage the information separately. However, one specific image processing apparatus 1 can centrally manage the display apparatus information. The information processing apparatus 3 can be the specific image processing apparatus 1. The other image processing apparatus 1 or the information processing apparatus 3 requests the display apparatus information from the specific image processing apparatus 1 as required. The specific image processing apparatus 1 transmits the display apparatus information to the requesting image processing apparatus 1. The other image processing apparatus 1 thus acquires the display apparatus information and can impose a restriction on the outputted image based on the display apparatus information. In this way, if the display apparatus information is centrally managed, maintenance of the display apparatus information becomes easier. In addition, each image processing apparatus 1 can use the latest display apparatus information.

Of course, the present invention is not limited to the embodiment described above, and many modifications and changes can be made to the embodiment described above without departing form the scope of the present invention. The display apparatus can also be an apparatus using a plasma display or an organic EL display.

The information processing apparatus can impose a restriction on the output image according to the display conditions and output the image to the display apparatus. That is, the control section of the information processing apparatus has a function of processing an image as with the control section of the image processing apparatus.

The display conditions can be changed. If the user does not approve a processing of an image when the user confirms the display conditions, the display conditions can be changed to tighten the restriction on the output image.

The display conditions can be determined taking into account not only the security levels of the viewing areas but also the security level of the image. An image containing confidential information is regarded as having a higher security level. Even if the security level of the viewing area is low, if the security level of the image is high, the display conditions are determined to impose a strict restriction on the output image. In this case, when the image is outputted, the control section of the image processing apparatus or the information processing apparatus determines the display conditions according to the security levels of the viewing areas and the security level of the image. Therefore, when the image containing confidential information is displayed, the image different from the original image is displayed with reliability. Thus, the security is improved, and leakage of the confidential information can be prevented.

The security levels of the viewing areas can be previously determined, rather than determining the security levels of the viewing areas each time an image is displayed. In this case, the users who see the display apparatus are separated into the viewing areas. The outside users are guided to the viewing area of the lower security level, and the inside users are guided to the viewing area of the higher security level.

The display apparatus can be a multiple-view display apparatus that displays different images to three viewing areas in three directions. The three viewing areas are a left-hand viewing area, a right-hand viewing area and a central viewing area set with reference to the screen. Furthermore, the display apparatus can be a display apparatus having a plurality of display panels arranged along a curved surface. The image displayed on each display panel can only be seen from the front and cannot be seen from an oblique position. The viewing areas are determined for the display panels.

What is claimed is:

1. A display system in which a display apparatus that simultaneously displays a plurality of images in such a manner that different images can be seen from different viewing areas set with reference to a screen and an image processing apparatus for processing images are connected to each other by a network, and the display apparatus displays an image outputted from the image processing apparatus,
wherein the image processing apparatus imposes a restriction on an image to be outputted according to the viewing area, and the display apparatus displays a plurality of images including the restricted image.

2. The display system according to claim 1, wherein a security level is set for each viewing area, a display condition is determined according to the security level of the viewing area, and the image processing apparatus imposes a restriction on the output image according to the display condition.

3. The display system according to claim 2, wherein the security level of the viewing area is determined depending on a user in the viewing area.

4. The display system according to claim 1, wherein the image processing apparatus outputs an image modified to be different from the original image according to the display condition, and the display apparatus displays the modified image.

5. The display system according to claim 4, wherein a security level is set for each viewing area, and a display condition is determined according to the security level of the viewing area.

6. The display system according to claim 1, wherein the image processing apparatus determines whether output of the image is permitted or not according to the display condition and inhibits output of the image if output of the image is not permitted.

7. The display system according to claim 6, wherein a security level is set for each viewing area, and a display condition is determined according to the security level of the viewing area.

8. The display system according to claim 1, wherein display conditions include whether enlargement of the image is permitted or not.

9. The display system according to claim 8, wherein the display apparatus displays an enlarged image when an image permitted to be enlarged is inputted thereto.

10. An image processing apparatus that is connected to a display apparatus that simultaneously displays a plurality of images in such a manner that different images can be seen from different viewing areas set with reference to a screen and outputs an image to the display apparatus,
wherein the image processing apparatus has a control section that imposes a restriction on the output image according to a display condition determined for each viewing area, and the control section outputs the restricted image to the display apparatus.

11. The image processing apparatus according to claim 10, wherein the control section modifies the image into an image different from the original image according to the display condition.

12. The image processing apparatus according to claim 11, wherein the control section determines whether output of the image is permitted or not according to the display condition and inhibits output of the image if output of the image is not permitted.
